(19) United States
(12) Patent Application Publication
(10) Pub. No.: US 2022/0284443 A1
(43) Pub. Date: Sep. 8, 2022

(54) INFORMATION PROCESSING SYSTEM

(71) Applicant: NOMURA RESEARCH INSTITUTE, LTD., Tokyo (JP)

(72) Inventor: Kengo Ohta, Tokyo (JP)

(21) Appl. No.: 17/481,442

(22) Filed: Sep. 22, 2021

(30) Foreign Application Priority Data
Mar. 2, 2021 (JP) 2021-032221

(51) Int. Cl. G06Q 30/00; G06Q 20/34; G06Q 40/00

(52) U.S. Cl. CPC G06Q 30/018; G06Q 20/346; G06Q 40/12

(57) ABSTRACT

An information processing device stores a unit emission amount that corresponds to GHG emissions per unit sale proceeds of a credit card member store, with respect to each of multiple credit card member stores. The information processing device acquires, from a credit card firm device, payment data associated with a purchase of a product or a service using a corporate card of a company. The payment data include information regarding a member store that has sold the product or service and also include a purchased amount. The information processing device derives GHG emissions associated with a purchase, based on a unit emission amount related to a member store specified by the payment data and also based on a purchased amount specified by the payment data. The information processing device provides, to a company device, information regarding GHG emissions associated with a purchase.

### BACKGROUND ART

### 1. Field

The present disclosure relates to a data processing technology, and particularly to an information processing system.

### 2. Description of the Related Art

In recent years, Environment, Social, and Governance (ESG) investment has been considered important in which, when investment in a company is determined, besides the amount of profits made by the company, what process (or business) has been conducted to make the profits is also taken into consideration (see Patent Literature 1, for example).

Patent Literature 1: Japanese Unexamined Patent Application Publication No. 2018-109936

It is considered that, in the future, supply chain emissions will be regarded important as a criterion for evaluating a company as an investment target. Supply chain emissions are the total emissions including emissions from the company (business operator) itself and all other emissions associated with its business activities. More specifically, supply chain emissions correspond to emissions of greenhouse gas (hereinafter, also referred to as “GHG”) generated in the entire workflow, including raw material procurement, manufacturing, logistics, sales, and disposal, for example.

Supply chain emissions are the sum of the scope 1 emissions, scope 2 emissions, and scope 3 emissions. The scope 1 emissions are direct emissions of GHG from the company (business operator) itself, such as in fuel combustion and industrial processes. The scope 2 emissions are indirect emissions caused by use of electricity, heat, and steam supplied from other companies. The scope 3 emissions are indirect emissions other than the scope 1 emissions and the scope 2 emissions, i.e., emissions from other companies associated with activities of the subject company (business operator).

Every company will be requested to properly disclose supply chain emissions in the future. However, in supply chain emissions, the scope 3 emissions are more difficult to calculate than the scope 1 emissions and the scope 2 emissions. Accordingly, many companies have not been able to disclose the scope 3 emissions so far.

### SUMMARY

The present disclosure has been made on the basis of the aforementioned issue recognized by the inventor, and a purpose thereof is to provide a technology for supporting derivation of the scope 3 emissions in the supply chain emissions of a company.

In response to the above issue, an information processing system according to one aspect of the present disclosure includes: a storage unit that stores a unit emission amount corresponding to greenhouse gas emissions per unit sale proceeds of a member store of a credit card, with respect to each of multiple member stores of the credit card; a first acquirer that acquires, from a device in a credit card firm, payment data associated with a purchase of a product or a service using a corporate card of a company, in which the payment data include information regarding a member store that has sold the product or service and also include a purchased amount; a deriver that derives greenhouse gas emissions associated with the purchase, based on a unit emission amount stored in the storage unit and related to a member store specified by the payment data and also based on a purchased amount specified by the payment data; and an information provider that provides, to the company, information regarding greenhouse gas emissions associated with the purchase.

Another aspect of the present disclosure also relates to an information processing system. The information processing system includes: a storage unit that stores a unit emission amount corresponding to greenhouse gas emissions per unit purchased amount of a product or a service, with respect to each of multiple products or services that could be purchased with a corporate card of a company; a first acquirer that acquires identification information and a purchased amount of a product or a service purchased with the corporate card, from a device in a member store that has sold the product or service or from a device in a credit card firm; a deriver that derives greenhouse gas emissions associated with the purchase, based on a unit emission amount stored in the storage unit and related to the purchased product or service and also based on a purchased amount of the purchased product or service; and an information provider that provides, to the company, information regarding greenhouse gas emissions associated with the purchase.

Optional combinations of the aforementioned constituting elements, and implementation of the present disclosure in the form of apparatuses, methods, computer programs, and recording media storing computer programs may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1A shows multiple categories in the Scope 3 Standard specified by the GHG Protocol;

FIG. 1B also shows multiple categories in the Scope 3 Standard specified by the GHG Protocol;

FIG. 2 shows a configuration of an information processing system according to a first embodiment;

FIG. 3 shows a configuration of payment data;

FIG. 4 is a block diagram that shows functional blocks included in an information processing device according to the first embodiment;

FIG. 5A shows a configuration of member store master data, and FIG. 5B shows a configuration of unit emission amount master data;

FIG. 6 shows a configuration of an information processing system according to a modification;

FIG. 7 is a block diagram that shows functional blocks included in an information processing device according to the modification;

FIG. 8 shows a configuration of an information processing system according to a second embodiment;

FIG. 9 shows a configuration of sales data;

FIG. 10 is a block diagram that shows functional blocks included in an information processing device according to the second embodiment; and

FIG. 11A shows a configuration of product-service master data, and FIG. 11B shows a configuration of unit emission amount master data.

### DETAILED DESCRIPTION

The invention will now be described by reference to the preferred embodiments. This does not intend to limit the scope of the present invention, but to exemplify the invention.

An entity of an apparatus or a method in the present disclosure includes a computer. When this computer executes a computer program, a function of the entity of an apparatus or a method in the present disclosure is implemented. The computer includes, as a main hardware configuration, a processor that operates according to a computer program. The type of the processor is not specified as long as it can implement a function by executing a computer program. The processor is constituted by one or more electronic circuits including a semiconductor integrated circuit (an IC, an LSI, and the like). A computer program is recorded on a non-transitory computer-readable recording medium, such as a ROM, an optical disk, and a hard disk drive. A computer program may be stored in advance on the recording medium or may be provided to the recording medium via a wide area communication network, such as the Internet.

An overview of embodiments will be described.

It is considered that, in the future, supply chain emissions will be regarded important as a criterion for evaluating a company as an investment target. Supply chain emissions are the sum of the scope 1 emissions, scope 2 emissions, and scope 3 emissions. The scope 3 emissions are more difficult to calculate than the scope 1 emissions and the scope 2 emissions. Accordingly, many companies have not been able to disclose the scope 3 emissions so far. Therefore, each embodiment proposes a technology for supporting derivation of the scope 3 emissions in the supply chain emissions of a company.

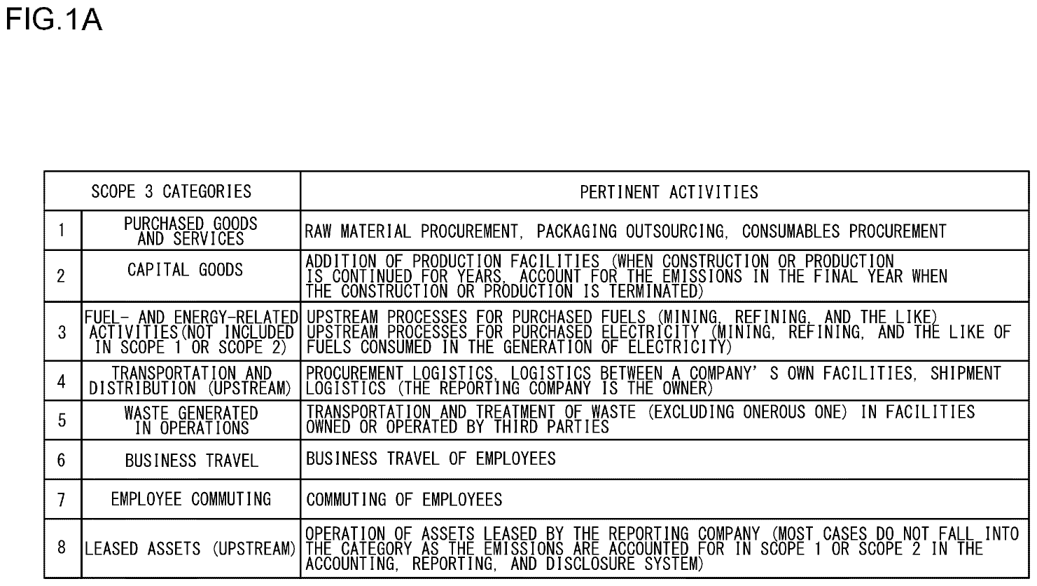

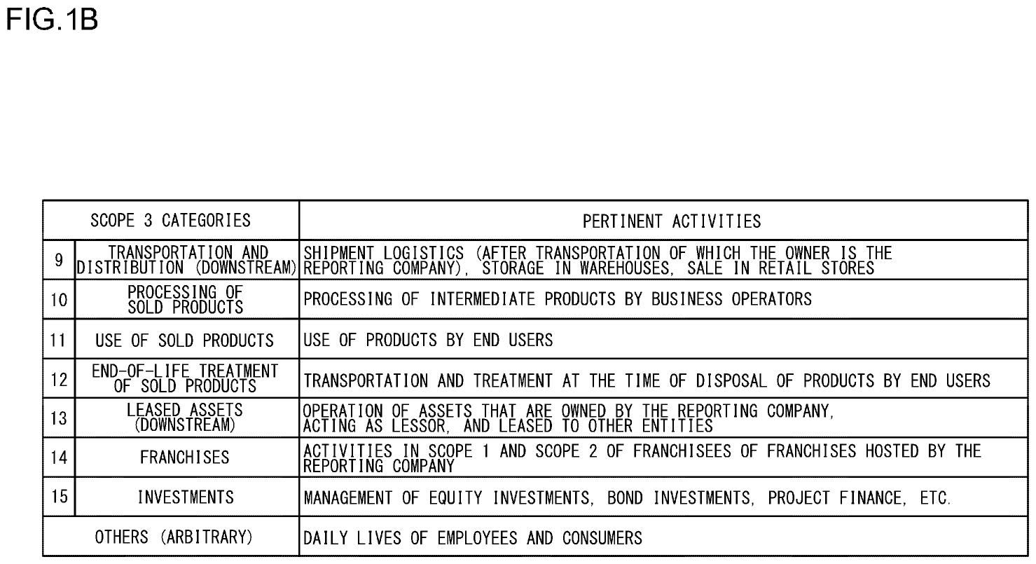

In the Scope 3 Standard specified by the Greenhouse Gas Protocol (GHG Protocol), the scope 3 is classified into 15 categories. FIGS. 1A and 1B show multiple categories in the Scope 3 Standard specified by the GHG Protocol. An information processing system in each embodiment mainly supports derivation of GHG emissions in category 1, category 6, and category 7 in the Scope 3 Standard. It can also be said that category 1, category 6, and category 7 correspond to GHG emissions generated in activities and purchases by employees.

The embodiments will be described in detail.

### First Embodiment

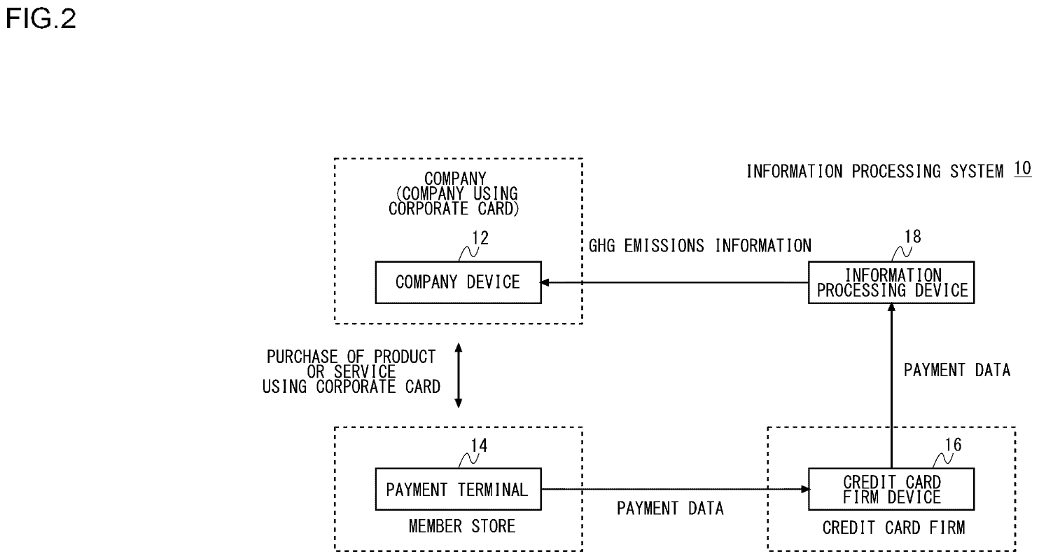

FIG. 2 shows a configuration of an information processing system 10 according to the first embodiment. The information processing system 10 of the first embodiment includes a company device 12, a payment terminal 14, a credit card firm device 16, and an information processing device 18. These devices are connected to each other via a communication network, such as a LAN, a WAN, and the Internet.

The company device 12 is an information processing device provided in a company using a corporate card. An employee in this company uses the company's own corporate card to purchase a product or a service from a member store of the credit card. A corporate card is a credit card used for company expense payment, such as business travel expenses and entertainment expenses, and, as the debit account of the credit card, a bank account of the company is designated.

The payment terminal 14 is a credit card payment terminal provided in a credit card member store that sells a product or a service to a company. The payment terminal 14 may be a credit authorization terminal (CAT) or a credit center terminal (CCT). A member store is a retail store or the like that has made a member store contract with the credit card firm. The credit card firm device 16 is an information processing device provided in the credit card firm.

When a product or a service is purchased using a corporate card, the payment terminal 14 in the member store transmits payment data associated with the purchase to the credit card firm device 16. The credit card firm device 16 then stores the payment data thus transmitted from the payment terminal 14 and performs payment processing based on the payment data. When the member store is a mail-order supplier, a server in the member store that provides a mail-order service to the company device 12 may transmit the payment data associated with the purchase to the credit card firm device 16. Based on the payment data provided from the credit card firm device 16, the information processing device 18 provides, to the company, a service of deriving GHG emissions associated with the purchase of a product or a service.

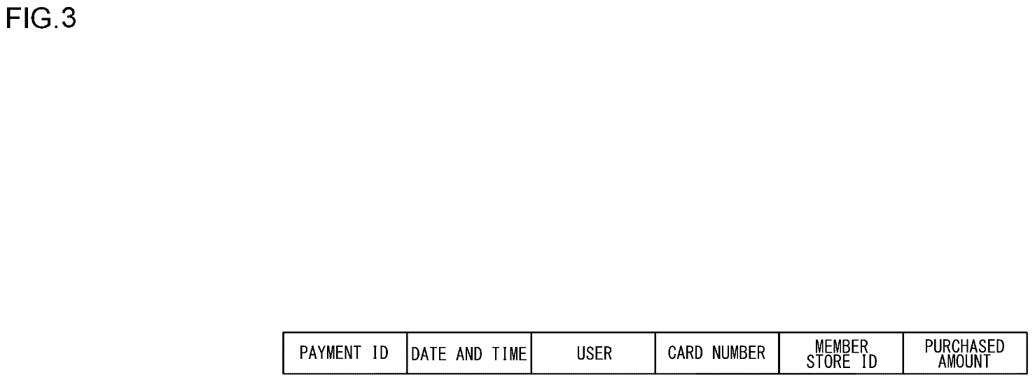

FIG. 3 shows a configuration of the payment data. The payment data include, as multiple items, PAYMENT ID, DATE AND TIME, USER, CARD NUMBER, MEMBER STORE ID, and PURCHASED AMOUNT. The item “PAYMENT ID” includes an ID unique for each payment. The payment ID can also be said to be an ID unique for each transaction of a product or a service. The item “DATE AND TIME” includes a date and time when a product or a service was purchased.

The item “USER” includes identification information of a user (a company in FIG. 2) that has used a corporate card to purchase a product or a service. The item “CARD NUMBER” includes the credit card number of a corporate card used for a purchase. The item “MEMBER STORE ID” includes an ID unique for each member store. The item “PURCHASED AMOUNT” includes the amount of purchase of a product or a service.

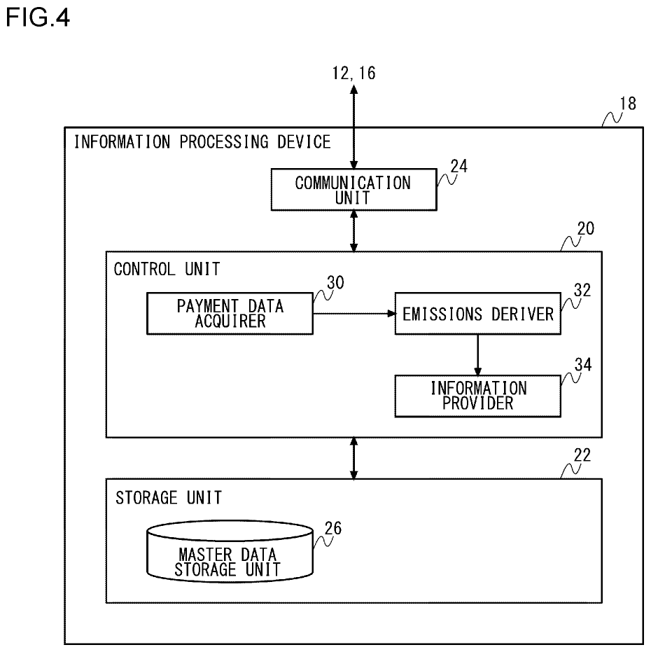

FIG. 4 is a block diagram that shows functional blocks included in the information processing device 18 of the first embodiment. Each block shown in a block diagram in this specification can be implemented by an element such as a processor, a CPU, or memory of a computer, an electronic circuit, or a mechanism in terms of hardware, and by a computer program or the like in terms of software. FIG. 4 illustrates functional blocks implemented by the cooperation of those components. Therefore, it will be obvious to those skilled in the art that the functional blocks may be implemented in a variety of forms by combinations of hardware and software. The functions of multiple blocks shown in FIG. 4 may be implemented by a single computer or may be distributed to and implemented by multiple computers.

The information processing device 18 includes a control unit 20, a storage unit 22, and a communication unit 24. The control unit 20 performs various data processes. The storage unit 22 stores data that the control unit 20 refers to or updates. The communication unit 24 communicates with an external device according to a predetermined communication protocol. The control unit 20 transmits or receives data to or from the company device 12 and the credit card firm device 16 via the communication unit 24.

The storage unit 22 includes a master data storage 26. The master data storage 26 stores a unit emission amount that corresponds to GHG emissions per unit sale proceeds of a credit card member store, with respect to each of multiple credit card member stores. The unit emission amount may be data of GHG emissions 10 g/yen, for example.

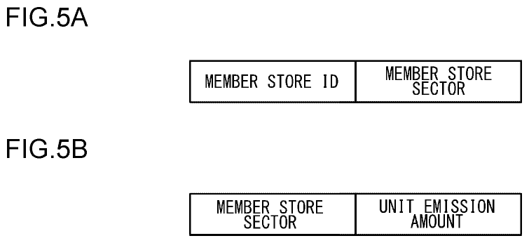

More specifically, the master data storage 26 stores member store master data and unit emission amount master data. FIG. 5A shows a configuration of the member store master data. The member store master data include IDs of multiple member stores related respectively to pieces of identification information of sectors (or types of business) that the multiple member stores belong to. The member store sectors may include aviation, railroads, and large appliance and electronics stores, for example.

FIG. 5B shows a configuration of the unit emission amount master data. The unit emission amount master data include multiple member store sectors related respectively to unit GHG emission amounts of the multiple member store sectors. The unit emission amount of each member store sector may be derived by dividing an average value of GHG emissions disclosed by multiple member stores that belong to the member store sector by an average value of sale proceeds of the multiple member stores.

Referring back to FIG. 4, the control unit 20 includes a payment data acquirer 30, an emissions deriver 32, and an information provider 34. A computer program for implementing the functions of the multiple functional blocks may be stored on a recording medium and may be installed on a storage of the information processing device 18 via the recording medium. Alternatively, such a computer program may be downloaded via a communication network and may be installed on a storage of the information processing device 18. Also, a CPU of the information processing device 18 may read the computer program into a main memory and execute the computer program to implement the functions of the multiple blocks.

The payment data acquirer 30 as a first acquirer acquires, from the credit card firm device 16, payment data associated with a purchase of a product or a service using a company's corporate card. As described previously with reference to FIG. 3, the payment data include information regarding the member store that has sold the product or service, and the purchased amount of the product or service.

The emissions deriver 32 derives GHG emissions associated with a purchase by the company, based on the unit emission amount, stored in the master data storage 26, related to the member store specified by the payment data, and the purchased amount specified by the payment data. The information provider 34 provides, to the company device 12, information regarding GHG emissions (hereinafter, also referred to as “GHG emissions information”) associated with the purchase by the company, derived by the emissions deriver 32.

There will now be described operations performed by the information processing system 10 of the first embodiment having the configurations set forth above, with reference to FIG. 2.

An employee in a company uses the company's own corporate card to purchase a product or a service sold by a member store. The payment terminal 14 in the member store transmits payment data associated with the purchase to the credit card firm device 16. The credit card firm device 16 accumulates the payment data transmitted from the payment terminal 14. The payment data acquirer 30 of the information processing device 18 accesses the credit card firm device 16 at a predetermined timing for deriving GHG emissions to acquire the payment data associated with a purchase by the company. For example, once a month regularly, the payment data acquirer 30 may acquire, from the credit card firm device 16, at least one piece of payment data associated with a purchase in a month.

The emissions deriver 32 of the information processing device 18 refers to the member store master data in the master data storage 26 to identify the member store sector related to the ID of the member store specified by the payment data acquired by the payment data acquirer 30 (such a member store is also referred to herein as the “subject member store”). The emissions deriver 32 also refers to the unit emission amount master data in the master data storage 26 to identify the unit emission amount related to the member store sector thus identified, as the unit emission amount of the subject member store. The emissions deriver 32 then derives the GHG emissions associated with the purchase specified by the payment data by multiplying the unit emission amount of the subject member store by the purchased amount specified by the payment data.

When the payment data acquirer 30 acquires multiple pieces of payment data associated with multiple times of purchases in a month, the emissions deriver 32 derives the GHG emissions for each piece of payment data. The emissions deriver 32 adds up the GHG emissions for the pieces of payment data to derive the sum as the GHG emissions generated in the entire purchase activities during the month. The GHG emissions may be a value of “XX t (ton)”, for example.

The information provider 34 of the information processing device 18 transmits, to the company device 12, the GHG emissions information indicating the GHG emissions derived by the emissions deriver 32 as the GHG emissions consistent with the Scope 3 Standard in the GHG protocol. Thus, the information processing system 10 according to the first embodiment can support the derivation of the scope 3 emissions in the supply chain emissions of a company, based on the actual results of purchases of products or services using the company's corporate card. For example, the information processing system 10 can assist a company to grasp and disclose its scope 3 emissions.

The present disclosure has been described based on the first embodiment. The features described in the first embodiment are intended to be illustrative only, and it will be obvious to those skilled in the art that various modifications to a combination of constituting elements or processes in the first embodiment could be developed and that such modifications also fall within the scope of the present disclosure.

There will be described modifications 1-1, 1-2, and 1-3 related to the first embodiment.

Modification 1-1

In the first embodiment, the unit GHG emission amount is determined for each member store sector (or each type of business). As a modification, for at least part of multiple member stores, the unit GHG emission amount may be determined for each member store. In this case, the master data storage 26 of the information processing device 18 may store the unit emission amount for each member store sector and may further store, for at least part of member stores, the unit emission amounts of the member stores themselves. For example, the member store master data in the master data storage 26 may contain member store sectors related respectively to member store IDs and may further contain, as an option, the unit emission amounts of the member stores themselves related respectively to the member store IDs. The unit emission amount of each member store may be derived by dividing the GHG emissions disclosed by the member store by the sale proceeds of the member store.

For a member store specified by payment data, when the unit emission amount of the member store is included in the member store master data, the emissions deriver 32 of the information processing device 18 may use the unit emission amount of the member store to derive the GHG emissions associated with the purchase specified by the payment data. Meanwhile, for a member store specified by payment data, when the unit emission amount of the member store is not included in the member store master data, the emissions deriver 32 may use the unit emission amount of a member store sector to which the member store belongs to derive the GHG emissions associated with the purchase specified by the payment data, as described in the first embodiment. According to this aspect, the scope 3 emissions in the supply chain emissions of a company can be derived further accurately. Also, each member store can be given an incentive to reduce the GHG emissions so as to be selected by companies.

Modification 1-2

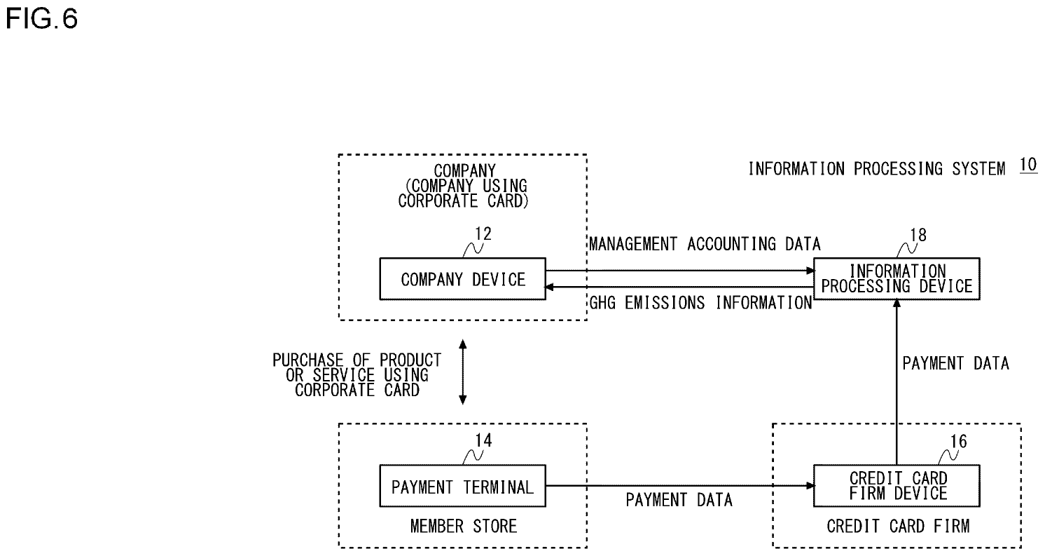

FIG. 6 shows a configuration of the information processing system 10 according to the modification. In the information processing system 10 of the present modification, based on accounting data retained in a company using a corporate card, the greenhouse gas emissions associated with a purchase are classified into one of the multiple categories in the Scope 3 Standard specified by the GHG Protocol.

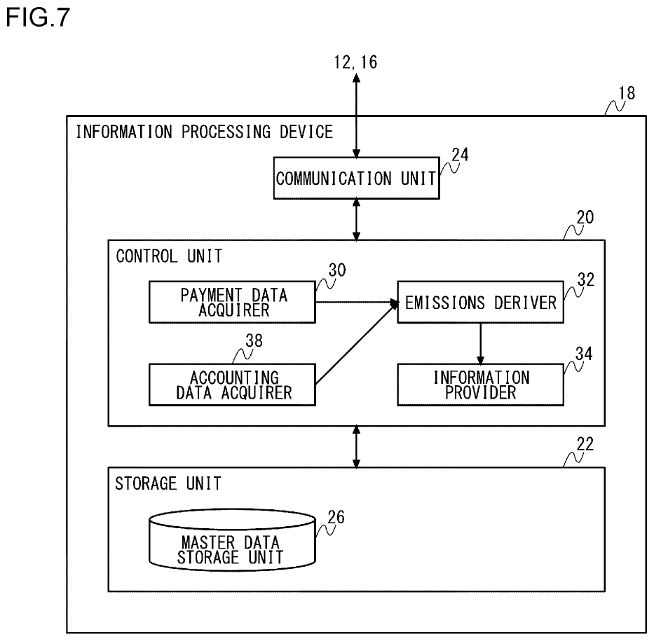

FIG. 7 is a block diagram that shows functional blocks included in the information processing device 18 according to the modification. In addition to the functional blocks shown in FIG. 4, the information processing device 18 of the present modification further includes an accounting data acquirer 38. The accounting data acquirer 38 as a second acquirer acquires accounting data of a company (such as management accounting data) associated with a purchase of a product or a service using a corporate card, from the company device 12 (such as an accounting system of the company).

For example, the accounting data acquirer 38 extracts, from the payment data, data that can uniquely identify a purchase of a product or a service using a corporate card, such as a combination among the payment ID, date and time, card number, member store ID, and purchased amount. Based on the extracted data, the accounting data acquirer 38 may request and acquire, from the company device 12, accounting data associated with the purchase identified by the extracted data. The accounting data include an account title, such as traveling expenses, commuting allowances, and tools furniture and fixtures, related to a purchase of a product or a service using a corporate card.

Based on the accounting data acquired by the accounting data acquirer 38, the emissions deriver 32 of the information processing device 18 classifies the GHG emissions associated with a purchase into one of the multiple categories in the Scope 3 Standard specified by the GHG Protocol (the 15 categories shown in FIGS. 1A and 1B). More specifically, the emissions deriver 32 classifies the GHG emissions associated with a purchase specified by a piece of payment data into one of the categories in the Scope 3 Standard, based on the account title specified by the accounting data associated with the purchase.

For example, when the account title is “traveling expenses”, the GHG emissions associated with the purchase may be classified into category 6 (Business travel). When the account title is “commuting allowances”, the GHG emissions associated with the purchase may be classified into category 7 (Employee commuting). When the account title is neither “traveling expenses” nor “commuting allowances”, the GHG emissions associated with the purchase may be classified into category 1 (Purchased goods and services).

The information provider 34 of the information processing device 18 transmits, to the company device 12, the GHG emissions information including the GHG emissions associated with a purchase derived by the emissions deriver 32 and a specific category in the Scope 3 Standard classified by the emissions deriver 32 related to each other. Thus, the information processing system 10 of the present modification can present, to a company, a category in the Scope 3 Standard that the GHG emissions associated with a purchase belong to, so as to support the management of the GHG emissions in the company more effectively.

When the emissions deriver 32 derives the GHG emissions based on each of multiple pieces of payment data, the emissions deriver 32 may add up, for each category, the GHG emissions based on multiple pieces of payment data. For example, the emissions deriver 32 may derive the GHG emissions (sum total) for each of category 1, category 6, and category 7 in the Scope 3 Standard. Accordingly, the information provider 34 may transmit, to the company device 12, the GHG emissions information indicating the GHG emissions (sum total) for each of category 1, category 6, and category 7 in the Scope 3 Standard.

Modification 1-3

The master data storage 26 of the information processing device 18 may store at least one of a category in the Scope 3 Standard for each member store and a category in the Scope 3 Standard for each member store sector. When the emissions deriver 32 derives GHG emissions associated with a purchase at a member store, if a specific category in the Scope 3 Standard for each member store is related to the member store, the emissions deriver 32 may classify the GHG emissions thus derived into the specific category in the Scope 3 Standard related to the member store. Meanwhile, when the emissions deriver 32 derives GHG emissions associated with a purchase at a member store, if a specific category in the Scope 3 Standard for each member store is not related to the member store, the emissions deriver 32 may classify the GHG emissions thus derived into a specific category in the Scope 3 Standard related to a member store sector that the member store belongs to. The information processing system 10 of the present modification also achieves effects similar to those in the aforementioned modification 1-2.

### Second Embodiment

The second embodiment of the present disclosure will be described mainly for features different from those in the first embodiment, and description of features in common will be omitted. A feature in the second embodiment may be arbitrarily combined with a feature in the first embodiment and a feature in a modification, as a matter of course. In the description of the second embodiment, like reference characters denote like or corresponding constituting elements in the first embodiment as appropriate.

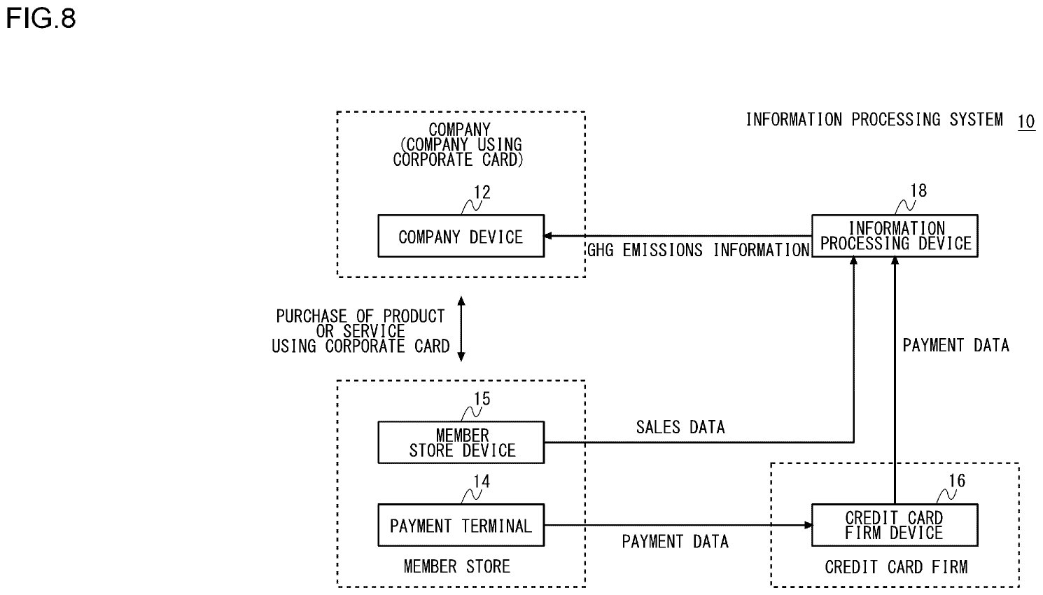

FIG. 8 shows a configuration of the information processing system 10 according to the second embodiment. In addition to the configuration of the information processing system 10 of the first embodiment, the information processing system 10 of the second embodiment further includes a member store device 15. The member store device 15 stores data regarding a product or a service sold by the member store to a company and paid with a corporate card of the company (hereinafter, such data may also be referred to as “sales data”).

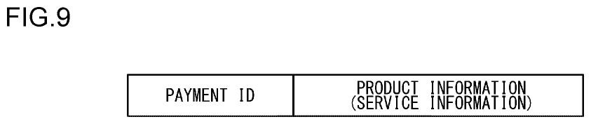

FIG. 9 shows a configuration of sales data. The sales data include a payment ID, which is also included in the payment data, and information regarding a sold product or a sold service (hereinafter, also referred to as “product information” or “service information”). The product information includes identification information of a product purchased with a corporate card, and the service information includes identification information of a service purchased with a corporate card.

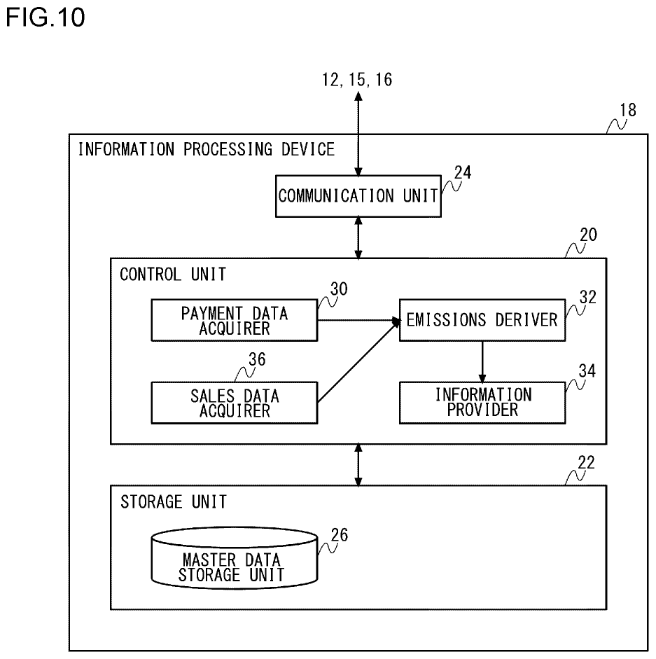

FIG. 10 shows functional blocks included in the information processing device 18 according to the second embodiment. In addition to the functional blocks provided in the information processing device 18 of the first embodiment, the information processing device 18 of the second embodiment further includes a sales data acquirer 36.

The master data storage 26 stores a unit emission amount that corresponds to GHG emissions per unit purchased amount of a product or a service, with respect to each of multiple products or services that could be purchased with a corporate card of a company.

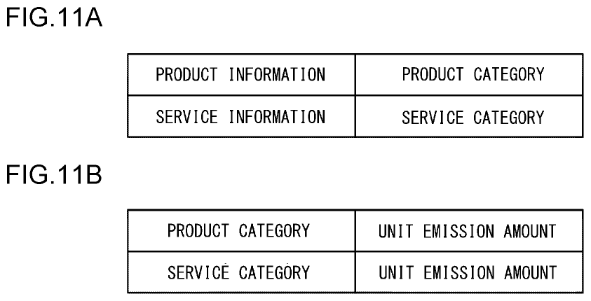

More specifically, the master data storage 26 stores product-service master data and unit emission amount master data. FIG. 11A shows a configuration of the product-service master data. The product-service master data include pieces of identification information of multiple products related respectively to product categories that the multiple products belong to (such as writing materials, PCs, and books). The product-service master data also include pieces of identification information of multiple services related respectively to service categories that the multiple services belong to (such as rail transport services, air transport services, and delivery services).

FIG. 11B shows a configuration of the unit emission amount master data. The unit emission amount master data include multiple product categories and service categories related respectively to unit GHG emission amounts of the multiple categories. As the unit GHG emission amount of each category, a value disclosed by a certain organization or agency (such as a government agency) may be set. For example, a value shown in the “Emissions Unit Value Database for Calculation of Greenhouse Gas Emissions, etc., by Organizations throughout the Supply Chain” disclosed by the Ministry of the Environment of Japan may be set.

Referring back to FIG. 10, the payment data acquirer 30 and the sales data acquirer 36 as the first acquirer acquire the identification information and the purchased amount of a product or a service purchased with a corporate card, from a device in a member store that has sold the product or service or from a device in the credit card firm.

The emissions deriver 32 derives GHG emissions associated with a purchase, based on the unit emission amount stored in the master data storage 26 and related to the purchased product or service, and the purchased amount of the purchased product or service. The information provider 34 provides, to the company device 12, information regarding the GHG emissions associated with the purchase.

There will now be described operations performed by the information processing system 10 of the second embodiment having the configurations set forth above, with reference to FIG. 8.

As is the case in the first embodiment, the payment data acquirer 30 of the information processing device 18 acquires payment data including a payment ID and a purchased amount from the credit card firm device 16. Based on the payment ID specified by the payment data, the sales data acquirer 36 of the information processing device 18 acquires, from the member store device 15, sales data including product information or service information related to the payment ID.

In the second embodiment, the purchased amount of a product or a service is extracted from the payment data acquired from the credit card firm device 16, while the identification information of the purchased product or service is extracted from the sales data acquired from the member store device 15. As a modification, when the payment data include both the identification information and the purchased amount of a purchased product or service, both may be extracted from the payment data. Also, when the sales data include both the identification information and the purchased amount of a purchased product or service, both may be extracted from the sales data.

The emissions deriver 32 of the information processing device 18 refers to the product-service master data in the master data storage 26 to identify the product category or service category related to the product information or service information specified by the sales data. The emissions deriver 32 also refers to the unit emission amount master data in the master data storage 26 to identify the unit emission amount related to the product category or service category thus identified. The emissions deriver 32 then derives the GHG emissions associated with the purchase specified by the payment data by multiplying the identified unit emission amount by the purchased amount specified by the payment data.

As is the case in the first embodiment, the information provider 34 of the information processing device 18 transmits, to the company device 12, the GHG emissions information indicating the GHG emissions derived by the emissions deriver 32 as the GHG emissions consistent with the Scope 3 Standard in the GHG protocol. Thus, the information processing system 10 according to the second embodiment can support the derivation of the scope 3 emissions in the supply chain emissions of a company, based on the company's actual results of purchases of products and services, similarly to the information processing system 10 according to the first embodiment. Also, since the unit GHG emission amount for a purchased product or service is used in the information processing system 10 of the second embodiment, the accuracy of estimation of GHG emissions can be further improved.

The present disclosure has been described based on the second embodiment. The features described in the second embodiment are intended to be illustrative only, and it will be obvious to those skilled in the art that various modifications to a combination of constituting elements or processes in the second embodiment could be developed and that such modifications also fall within the scope of the present disclosure.

There will be described modifications 2-1, 2-2, and 2-3 related to the second embodiment.

Modification 2-1

In the second embodiment, the unit GHG emission amount is determined for each product category or each service category. As a modification, for at least part of multiple products or services, the unit GHG emission amount may be determined for each product or service. In this case, the master data storage 26 of the information processing device 18 may store the unit emission amount for each product category or each service category and may further store, for at least part of products or services, the unit emission amount of the product or service itself.

For example, the product-service master data in the master data storage 26 may contain product categories related respectively to pieces of product information and may further contain, as an option, the unit emission amounts of the products themselves related respectively to the pieces of product information. Also, the product-service master data in the master data storage 26 may contain service categories related respectively to pieces of service information and may further contain, as an option, the unit emission amounts of the services themselves related respectively to the pieces of service information. As the unit emission amount of a product or a service, a unit emission amount disclosed by a member store, the manufacturer of the product, or the provider of the service (or a value obtained by dividing the GHG emissions of the product or service by the price of the product or service) may be stored in the master data storage 26.

When the master data storage 26 stores the unit emission amount of a purchased product or service, the emissions deriver 32 of the information processing device 18 may use the unit emission amount of the product or service to derive the GHG emissions associated with the purchase. Meanwhile, when the master data storage 26 does not store the unit emission amount of a purchased product or service, the emissions deriver 32 may use the unit emission amount of a category to which the product or service belongs to derive the GHG emissions associated with the purchase, as described in the second embodiment. According to this aspect, the scope 3 emissions in the supply chain emissions of a company can be derived further accurately. Also, each product manufacturer or service provider can be given an incentive to reduce the GHG emissions so as to be selected by companies.

Modification 2-2

As is the case in the modification 1-2 described previously, in the information processing system 10 of the present modification, the greenhouse gas emissions associated with a purchase are classified into one of the multiple categories in the Scope 3 Standard specified by the GHG Protocol, based on accounting data retained in a company using a corporate card.

In addition to the functional blocks shown in FIG. 10, the information processing device 18 of the present modification further includes the accounting data acquirer 38 shown in FIG. 7. The accounting data acquirer 38 as a second acquirer acquires accounting data of a company (such as management accounting data) associated with a purchase of a product or a service using a corporate card, from the company device 12 (such as an accounting system of the company).

Based on the accounting data acquired by the accounting data acquirer 38, the emissions deriver 32 of the information processing device 18 classifies the GHG emissions associated with a purchase into one of the multiple categories in the Scope 3 Standard specified by the GHG Protocol (the 15 categories shown in FIGS. 1A and 1B). More specifically, the emissions deriver 32 classifies the GHG emissions associated with a purchase specified by a piece of payment data into one of the categories in the Scope 3 Standard, based on the account title specified by the accounting data associated with the purchase.

The information provider 34 of the information processing device 18 transmits, to the company device 12, the GHG emissions information including the GHG emissions associated with a purchase derived by the emissions deriver 32 and a specific category in the Scope 3 Standard classified by the emissions deriver 32 related to each other. Thus, as is the case in the aforementioned modification 1-2, the information processing system 10 of the present modification can present, to a company, a category in the Scope 3 Standard that the GHG emissions associated with a purchase belong to, so as to support the management of the GHG emissions in the company more effectively.

Modification 2-3

The master data storage 26 of the information processing device 18 may store at least one of a category in the Scope 3 Standard for each product or service and a category in the Scope 3 Standard for each product category or service category. When the emissions deriver 32 derives GHG emissions associated with a purchase of a product or a service, if a specific category in the Scope 3 Standard for each product or service is related to the product or service, the emissions deriver 32 may classify the GHG emissions thus derived into the specific category in the Scope 3 Standard related to the product or service. Meanwhile, when the emissions deriver 32 derives GHG emissions associated with a purchase of a product or a service, if a specific category in the Scope 3 Standard for each product or service is not related to the product or service, the emissions deriver 32 may classify the GHG emissions thus derived into a specific category in the Scope 3 Standard related to a product category or a service category that the product or service belongs to. The information processing system 10 of the present modification also achieves effects similar to those in the aforementioned modification 2-2.

Modification 3-1

The present modification relates to a combination of the information processing system 10 of the first embodiment and the information processing system 10 of the second embodiment. The information processing device 18 of the present modification includes the master data storage 26, the payment data acquirer 30, the emissions deriver 32, the information provider 34, the sales data acquirer 36, and the accounting data acquirer 38.

When the category of a purchased product or service can be identified, such as when the product information specified by the sales data is related to a specific product category in the product-service master data, the emissions deriver 32 uses the unit emission amount related to the identified category of the product or service to derive the GHG emissions associated with the purchase. Meanwhile, when the category of a purchased product or service cannot be identified, such as when the product information specified by the sales data is not included in the product-service master data, the emissions deriver 32 uses the unit emission amount related to the member store specified by the payment data to derive the GHG emissions associated with the purchase.

In the present modification, even when the unit emission amount based on a purchased product or service cannot be obtained, the unit emission amount based on the member store that has sold the product or service can be obtained, so that the GHG emissions associated with a purchase can be derived in any case. Also in the modification 3-1, the emissions deriver 32 may use accounting data of a company acquired from the company device 12 to classify the GHG emissions associated with a purchase into one of the categories in the Scope 3 Standard.

Modification 3-2

The present modification relates to a combination of the modification 1-1 related to the first embodiment and the modification 2-1 related to the second embodiment. The information processing device 18 of the present modification includes the master data storage 26, the payment data acquirer 30, the emissions deriver 32, the information provider 34, the sales data acquirer 36, and the accounting data acquirer 38.

The emissions deriver 32 performs one of the following processes 1-4, which are prioritized in this order. When a higher priority process is performed, processes with lower priorities will be skipped.

Process 1: When the unit emission amount of a purchased product or service is set, the emissions deriver 32 uses the unit emission amount of the product or service to derive the GHG emissions associated with the purchase.

Process 2: When the unit emission amount of a purchased product or service is not set but when the category of the purchased product or service can be identified, the emissions deriver 32 uses the unit emission amount related to the identified category of the product or service to derive the GHG emissions associated with the purchase.

Process 3: When the category of a purchased product or service cannot be identified but when the unit emission amount of a member store specified by the payment data is set, the emissions deriver 32 uses the unit emission amount of the member store to derive the GHG emissions associated with the purchase.

Process 4: When the category of a purchased product or service cannot be identified and when the unit emission amount of a member store specified by the payment data is not set either, the emissions deriver 32 uses the unit emission amount of a member store sector to which the member store belongs to derive the GHG emissions associated with the purchase.

In the present modification, based on the disclosed conditions of the GHG emissions related to a purchased product or service or to a member store, the accuracy of derivation of the GHG emissions associated with a purchase can be improved as much as possible. Also in the modification 3-2, the emissions deriver 32 may use accounting data of a company acquired from the company device 12 to classify the GHG emissions associated with a purchase into one of the categories in the Scope 3 Standard.

Modification 3-3

A modification applicable to both the information processing system 10 of the first embodiment and the information processing system 10 of the second embodiment will be described. The information processing system 10 may be connected with a device in a carbon credit firm via a communication network. The control unit 20 of the information processing device 18 may further include an offset unit. The offset unit may perform, in cooperation with the device in the carbon credit firm, offset processing of the GHG emissions associated with a purchase derived by the emissions deriver 32. The offset processing may be processing for executing a transaction of paying an offset fee to a carbon credit firm and acquiring, from the carbon credit firm, a carbon credit corresponding to the GHG emissions associated with a purchase. The offset fee may be paid later by the company to an organization that retains the information processing device 18. According to this aspect, by using the service by means of the information processing device 18, a company can make up for the GHG emissions associated with a purchase.

Modification 4

Each of the aforementioned embodiments describes a method for deriving GHG emissions of a company based on payment data. However, in actuality, besides the climate change due to GHG emissions, other environmental issues are also caused by excessive consumption of all natural resources (such as plants, animals, air, water, soil, and minerals). Accordingly, natural resources are regarded as “natural capital”, and the consumption thereof is increasingly required to be grasped, managed, and disclosed. Since part of the natural capital is consumed by economic activities, the consumption thereof can be grasped based on payment, similarly to the case of GHG. For example, only about 0.01% of the water on Earth corresponds to freshwater resources that human beings can use, and there have been growing concerns about depletion of the freshwater resources due to the increasing amount of use thereof. Meanwhile, the amounts of water used in production processes of various foods, industrial products, and daily necessities can be grasped as “water footprints”. Also, the amount of water resources required when a product equivalent to an imported product is domestically produced can be quantified as “virtual water”.

In the abovementioned context, when the amount of water resources used in economic activities in a specific region is grasped, managed, and disclosed, for example, at least one of unit water resources usage for each product or service and unit water resources usage for each product category or service category may be stored in the master data storage 26 of the information processing device 18. Accordingly, the emissions deriver 32 of the information processing device 18 may derive water resources usage associated with a purchase specified by payment data by multiplying the unit water resources usage by the purchased amount specified by the payment data.

Optional combinations of the aforementioned embodiments and modifications may also be practiced as additional embodiments of the present disclosure. Such an additional embodiment made by combination has the effect of each of the combined embodiments and modifications. Also, it will be obvious to those skilled in the art that the function to be achieved by each constituent feature described in the claims may be implemented by each of the constituting elements described in the embodiments or modifications, or by the cooperation of those constituting elements.

What is claimed is:

1. An information processing system, comprising:
a storage unit that stores a unit emission amount corresponding to greenhouse gas emissions per unit sale proceeds of a member store of a credit card, with respect to each of a plurality of member stores of the credit card;
a first acquirer that acquires, from a device in a credit card firm, payment data associated with a purchase of a product or a service using a corporate card of a company, the payment data including information regarding a member store that has sold the product or service and also including a purchased amount;
a deriver that derives greenhouse gas emissions associated with the purchase, based on a unit emission amount stored in the storage unit and related to a member store specified by the payment data and also based on a purchased amount specified by the payment data; and
an information provider that provides, to a device in the company, information regarding greenhouse gas emissions associated with the purchase.

2. The information processing system according to claim 1, wherein
the storage unit stores a unit emission amount for each type of business and further stores unit emission amounts of at least part of member stores, and
the deriver derives greenhouse gas emissions associated with the purchase by using, when a unit emission amount of a member store specified by the payment data is stored in the storage unit, the unit emission amount of the member store and by using, when a unit emission amount of a member store specified by the payment data is not stored in the storage unit, the unit emission amount of a type of business to which the member store belongs.

3. An information processing system, comprising:
a storage unit that stores a unit emission amount corresponding to greenhouse gas emissions per unit purchased amount of a product or a service, with respect to each of a plurality of products or services that could be purchased with a corporate card of a company;
a first acquirer that acquires identification information and a purchased amount of a product or a service purchased with the corporate card, from a device in a member store that has sold the product or service or from a device in a credit card firm;
a deriver that derives greenhouse gas emissions associated with the purchase, based on a unit emission amount stored in the storage unit and related to the purchased product or service and also based on a purchased amount of the purchased product or service; and
an information provider that provides, to a device in the company, information regarding greenhouse gas emissions associated with the purchase.

4. The information processing system according to claim 3, wherein
the storage unit stores a unit emission amount for each product category or each service category and further stores unit emission amounts of at least part of products or services, and
the deriver derives greenhouse gas emissions associated with the purchase by using, when a unit emission amount of the purchased product or service is stored in the storage unit, the unit emission amount of the product or service and by using, when a unit emission amount of the purchased product or service is not stored in the storage unit, the unit emission amount of a product category or a service category to which the product or service belongs.

5. The information processing system according to claim 1, further comprising a second acquirer that acquires, from a device in the company, accounting data of the company associated with a purchase of a product or a service using the corporate card, wherein
based on the accounting data acquired by the second acquirer, the deriver classifies greenhouse gas emissions associated with the purchase into one of a plurality of categories in the Scope 3 Standard specified by the Greenhouse Gas Protocol.

6. The information processing system according to claim 3, further comprising a second acquirer that acquires, from a device in the company, accounting data of the company associated with a purchase of a product or a service using the corporate card, wherein
based on the accounting data acquired by the second acquirer, the deriver classifies greenhouse gas emissions associated with the purchase into one of a plurality of categories in the Scope 3 Standard specified by the Greenhouse Gas Protocol.
